(19) United States
(12) Patent Application Publication
(10) Pub. No.: US 2018/0036101 A1
(43) Pub. Date: Feb. 8, 2018

(54) PROVIDING NON-INVASIVE, NON SURGICAL FACIAL SUPPORT, FACIAL PROPORTIONING AND BITE OPTIMIZATION

(71) Applicant: Samuel Charles Muslin, Pacific Palisades, CA (US)

(72) Inventor: Samuel Charles Muslin, Pacific Palisades, CA (US)

(21) Appl. No.: 15/704,822

(22) Filed: Sep. 14, 2017

Related U.S. Application Data
(63) Continuation-in-part of application No. 14/103,682, filed on Dec. 11, 2013, now abandoned.

(51) Int. Cl. A61C 7/36; A61C 7/00

(52) U.S. Cl. CPC A61C 7/36; A61C 7/002

(57) ABSTRACT

A method for providing non-invasive and non-surgical facial proportioning for a patient to realize a modified bite and jaw positioning includes bonding a set of dental restorations to at least one set of dental arches of the patient is described. The bonding includes: cleaning a surface of the at least one set of dental arches, wherein the cleaning including: applying micro air-abrasion to surface contaminants on the surface of the at least one set of dental arches; etching away the surface contaminants; chemically activating the surface of said at least one set of dental arches; and applying a desensitizer and antibacterial material to the surface, wherein the at least one set of dental restorations provides a dental reconstruction that achieves the modified bite and jaw positioning for the patient.

### BACKGROUND

Patients with overbites, bad bites, temporomandibular joint (TMJ) problems and under bites are physically handicapped due to their pain, head and neck stress and seek treatment. But, many people are suffering without knowing that bite problems and resulting bad jaw position are decreasing the quality of their lives. This treatment is more valuable than ever before because people are living much longer. Life expectancy has increased and the senior years of our life is physically compromised due to bad bites and worn down teeth.

Everyone has an optimal jaw position for his or her TMJ, bite and facial structures but few people ever experience it because the size, location, angles and position of the teeth would have to line up perfectly with the TMJ and additionally have the optimal jaw position. As the teeth age, the teeth wear down and the jaw position worsens from the original position that was most likely to be a less than optimal position.

Most of us are living our lives physically compromised because of our bite. We may have sleeping problems, the clarity of our speech deteriorates with age, TMJ pain, headaches, neck and shoulder discomfort, insufficient tongue space and sinus issues that are rarely associated with the deteriorating jaw position and bite.

Traditional dentistry provides various techniques for addressing dental problems (e.g., overbites, under bites, eroded bites, etc.). Orthodontists recommend jaw surgery and years of braces; general dentists may recommend smile dentistry to camouflage the health problem; and/or oral surgeons generally recommend jaw surgery and braces. Prosthodontists, neuromuscular dentists and general dentists recommend full mouth reconstructions that require grinding down all of the patients healthy teeth for porcelain crowns. Grinding down healthy teeth requires far more unnecessary root canal treatment, tooth loss and eventual dental implants while jaw surgery can cause permanent health problems that cannot be reversed.

In many instances, in order to correct these dental problems such as overbites, under bites, and TMJ pain, patients endure hospitalization to have one or both of their jaws cut, have their jaw wired shut during the healing period, have their teeth ground down, and wear braces for an extended period of time. The complications and risks of jaw surgery are extensive and the seemingly endless amount of time required to wear braces and heal from the surgery can be exhausting and very expensive for the patient. The complications and risks of grinding down teeth for crowns are significant and can leave the patient in constant pain or discomfort with compromised structural integrity of the teeth. Thus, the traditional treatment methods for correcting bite and jaw positions present many problems and undesirable side effects. These traditional treatments can physically harm the patient instead of providing a solution.

### BRIEF DESCRIPTION OF DRAWINGS

FIGS. 1A and 1B show TMJ image photos taken with a complex motion tomography machine, in accordance with embodiments.

FIGS. 2A and 2B illustrate before and after front view pictures of Patient “A” with an under bite, in accordance with embodiments.

FIGS. 2C and 2D illustrate before and after side profile pictures of Patient “A” with an under bite, in accordance with embodiments.

FIGS. 3A and 3B illustrate before and after side profile pictures of Patient “B” with an overbite, in accordance with embodiments.

FIGS. 4A and 4B illustrate before and after front view pictures of Patient “C” with an eroded and aging bite, in accordance with the embodiments.

FIG. 5 is a flow chart of an example method 500 for providing facial proportioning for a patient to realize an idealized bite and jaw positioning, in accordance with embodiments.

FIG. 6 is a flow chart of an example method 600 for providing facial proportioning for a patient to realize an idealized bite and jaw positioning, in accordance with embodiments.

FIG. 7 is a flow chart of an example method 700 for providing facial proportioning for a patient to realize an idealized bite and jaw positioning, in accordance with embodiments.

FIG. 8 is a flow chart of an example method 800 for providing facial proportioning for a patient to realize an idealized bite and jaw positioning, in accordance with embodiments.

FIG. 9 is a flow chart of an example method 900 for providing facial proportioning for a patient to realize an idealized bite and jaw positioning, in accordance with embodiments.

FIG. 10 is a block diagram of an example system 1000 for providing facial proportioning for a patient to realize an idealized bite and jaw positioning, in accordance with embodiments.

The drawings referred to in this description should be understood as not being drawn to scale except if specifically noted.

### DESCRIPTION OF EMBODIMENTS

The discussion below begins with a brief overview description of embodiments of the present technology for providing a patient with idealized facial support and facial proportioning non-invasively. The discussion then turns to a description of various bite and jaw positions that are less than ideal and the consequences therefrom to patients. Further, an explanation is given of traditional dental techniques of addressing these problems and consequences. The discussion then turns to a detailed description of embodiments of the present technology that enable the idealization of a patient's bite and jaw position, thereby resolving the dental problems associated with a poor bite and jaw position.

### Overview

Face Lift Dentistry® is a non-invasive method, and VENLAY® Restorations are non-invasive restorations with very low risk to treat bite problems, overbites, under bites, bad bites, chewing efficiency, speech and TMJ problems, headaches, small chins, large chins, clicking and popping jaw joints that creates improved facial proportioning and improved facial profile. JawTrac® jaw positioning helps patients to realize an idealized bite, chin size and jaw position and experience the position before any dental restorations are attempted. A healthy jaw position can be achieved by testing with the JawTrac® jaw positioning appliance that simulates the bonding of VENLAY® Restorations to at least one set of teeth (all of the upper teeth or all of the lower teeth or both upper and lower teeth) in the dental arches of the patient which is described. Bites are corrected when all of the upper teeth and/or all of the lower teeth are restored.

If the patient being treated has old porcelain crowns they are replaced with new porcelain crowns but if the patient also has healthy teeth, this “breakthrough” method restores the patient's healthy teeth without grinding them down. All of the dentists throughout the world as far as we know, are grinding down healthy teeth, (damaging the health of the teeth) when they are doing a full mouth reconstruction type of bite correction. Grinding down healthy teeth is painful to the patient, requires many more dental shots or injections, causes unnecessary damage to the patient's teeth, creates unnecessary root canal treatment and usually requires narcotic pain medication. VENLAY® Restorations do not require grinding down the patients healthy teeth saving the teeth, preserving the foundation of the teeth, and the treatment will be much less painful or completely painless with far less risk. No narcotic pain medication is necessary.

The bonding includes: cleaning a surface of all of the teeth in the upper arch, applying a surface disinfectant, micro air-abrasion to remove all surface contaminants and increase the surface area for bonding strength; etching away other surface contaminants and chemically activate the surface; and applying a desensitizer and antiseptic material to the surface of all exposed dentin, a bonding agent and bonding adhesive for enamel and dentin wherein VENLAY® restorations provides a new jaw position, chin size improvement, better facial profile, healthy bite, chewing efficiency, improved sleep, TMJ pain reduction, head, neck pain relief and enormous cosmetic benefits as looking and feeling physically years younger along with reversing the effects of aging.

The bite reconstruction is completed without the pain and risk of jaw surgery, without the years of braces, without damaging the teeth with porcelain crowns or porcelain veneers because all of the treatment is non-invasive, predictable and tested in advance which is both a quicker and a safer treatment than any other method available today.

Various embodiments of the present technology provide non-surgical methods for providing a patient with facial support and facial proportioning, enabling the patient's bite position (i.e., the way that the patient's teeth fit together) and jaw position to be modified. More particularly, embodiments include using a novel bonding procedure that provides a non-invasive and pain-free method of applying a dental restoration(s) to a patient's teeth. Some embodiments use information acquired from low radiation exposure jaw imaging generated images of the jaw positions to create dental restorations (called a test bite restoration) that provide a patient with modified (e.g., idealized) facial support and facial proportioning without grinding down their healthy natural teeth, without jaw surgery, without invasive porcelain veneers, without porcelain crowns or braces, etc.

One advantage of this treatment over traditional bite correction or full mouth reconstruction dentistry is that it is non-invasive, more predictable, has far less risk, keeps the patient's natural healthy teeth intact, and has far less pain. These advantages make it easier and safer for senior patients to be treated and for much younger patients with healthy teeth to be treated with this method. Far more patients can have optimal health easier, safer and quicker than ever before in the history of dentistry with jawtrac®, Venlay® restorations using the face lift dentistry® method.

None of the patient's healthy teeth need to be ground down with the dental restorations described herein which are one of the biggest treatment improvements in bite correction dentistry during the last century. The problem with old dental treatment is that healthy teeth are being irreversibly damaged because they are ground down. Dentists are grinding down healthy teeth for porcelain crowns or porcelain veneers when treating patients for bite problems and for cosmetic purposes but they never reach the optimal jaw position in many cases. Patients are also getting jaw surgeries and braces that have much greater risk, more pain, takes years instead of weeks, and are far less predictable results than the methods described herein.

This new method of treatment is the future of bite reconstruction and full mouth reconstruction dentistry. The emphasis of this care is that it is non-invasive as none of the patient's healthy teeth are ground away and the new jaw position can be seen by the dentist and tested in advance of any treatment to the patient's teeth. You cannot test jaw surgery in advance and you cannot test orthodontics in advance of treatment.

### Bite and Jaw Position Problems

A less than ideal bite and jaw position may occur in a wide variety of circumstances, such as, but not limited to, the following: an overbite; an under bite; an uncomfortable bite, an eroded bite; and an aging bite. Following is a general description of an overbite and under bite as it relates to embodiments to be presented in detail below.

### Overbite

An overbite commonly refers to a lower jaw being too far behind the upper jaw or a misalignment of the teeth. The upper teeth overlap the lower teeth which forces the lower jaw back towards the patient's ears. The lower jaw commonly appears physically smaller than the upper jaw and it leads to the perception of a weak chin and small jaw. Adverse consequences of an overbite include, but are not limited to, the following: jaw pain, neck pain, headaches, clicking and popping jaw, teeth grinding, enamel wear, inhibited breathing, low self-esteem, slurred speech, premature aging, and the like.

### Under Bite or Class III Bite

An under bite or Class III Bite commonly refers to a malocclusion in which the lower teeth protrude beyond and in front of the upper teeth. The lower jaw commonly appears physically larger than the upper jaw because of the associated bite and jaw position. An under bite may cause excessive enamel wear on the back teeth, digestive problems, trouble chewing, slurred speech, annunciation problems, headaches, TMJ pain, clicking and popping jaws, self-confidence issues, premature aging, low self-esteem, and the like.

### Eroded Bite or Aging Bite

An eroded bite or aging bite commonly refers to teeth or a dental arch(s) that are shortened and worn. The teeth may exhibit extensive enamel wear that can be uneven, the cusps of the teeth are worn down flat thereby causing the loss of tongue space, sleeping problems, breathing problems, a misaligned jaw, TMU problems, jaw alignment problems, trouble chewing, digestive problems, inhibited airway access, jaw pain, facial tension, a clicking and popping jaw, grinding, clenching, problems sleeping, low oxygen levels, premature aging, headaches, and the like. Worn down teeth also cause facial collapse as the shape of the patient's face becomes shorter and rounder. This is the definition of premature aging from worn down teeth. Most patients that are 50 years of age have significant tooth wear, bite issues, facial wrinkles, small chins, and short round faces that make they appear as if they are angry and older than their age group. It is the “grumpy old man or old woman look.” Life expectancy is longer than ever which makes bite optimization with the Face Lift Dentistry® method the most predictable, least invasive and pain free method available in dentistry today.

Consequences of a Less than Ideal Bite and Jaw Position

As indicated above, a person with a less than ideal bite and jaw position may experience a multitude of problems. A more extensive recounting of these problems includes, but is not limited to, the following: aging effects (e.g., weak chin, disappearing lips, sunken cheeks, jutting chins, sagging skin, bad facial shape, imbalances in the proportions of the profile, wrinkles, facial collapse, sleeping problems, and the like); chewing problems; digestive problems (e.g., acid reflux); reduced nutrient absorption; reduced airway; difficulty breathing; sleep problems; body fatigue; TMJ pain; muscle tiredness; tension in the face; headaches; chronic clenching; grinding of the teeth; and low self-esteem. A person may find it necessary to take medication to alleviate many of the problematic symptoms related to poor bite and jaw positioning. The Face Lift Dentistry® method is a mechanical solution to a mechanical problem using non-invasive VENLAY® restorations. An embodiment of the present technology generates the VENLAY®, owned by Dr. Sam Muslin.

Although non-invasive VENLAY® restorations are referred to herein, for purposes of clarity, the following discussion will refer to the encompassing idea as non-invasive restorations.

As noted above, a less than idealized bite may affect many aspects of a person's life. A more thorough description of several examples (digestive problems, TMJ pain, clenching/grinding, aging, reduced airway, and the like) is described immediately below.

### Digestive Problems

A person's poor bite and jaw positioning affects that person's ability to chew his food thoroughly and efficiently. Many problems result when a person's bite and jaw position are less than ideal or when their upper and lower jaw are misaligned. When any part of the chewing system is out of synch, it can lead to many problems. Poor bite positioning may both subconsciously and consciously cause a person to stop chewing his food thoroughly or comfortably. For example, when a person finds that it is difficult and/or painful to close his teeth together, the person may simply chew his food as little as possible. This partially broken down food is then introduced into the digestive tract. The digestive tract is required to break down the food at least to the extent that the chewing process should have. Over time, digestive issues, such as acid reflux, may occur as the body struggles to digest large food particles. Many patients cannot physically chew their food properly because of the worn down bite leaving little room for the patient's tongue.

### TMJ Pain

In some cases, the TMJ muscles overcompensate for a bad bite position. The jaw muscles of a person force his teeth to meet each other in order that the food may be chewed. By repeatedly forcing his bite to assume an unhealthy position, a person may begin to experience muscle tightness, pain and fatigue in his jaw, face, neck, and ears area.

### Clenching/Grinding

A misaligned bite and jaw position may lead to increased clenching and/or grinding. During sleep, some amount of clenching and grinding of the teeth is normal. As this night time reflex progresses over time, it can lead to, at least, enamel erosion, shortened or worn down teeth, root exposure and tooth sensitivity, and tooth mobility or loss. The more clenching and grinding that is done, both during the day and night, the more the bite is worn down (as well as unevenly worn down). This situation tends to get worse over time and the symptoms increase, causing greater tooth sensitivity, tooth damage, jaw pain, muscle tightness, headaches and difficulty chewing. The TMJ and the bite are supposed to function in harmony. Because we are living so much longer, the functional harmony is critical to the quality of life. Many patients don't even know that many of the health problems happening after age 50 are bite related.

### Premature Aging

As a person ages, his teeth get shorter (i.e., the bite position loses height and dimension). From the cosmetic perspective, as teeth are worn down and getting shorter, the teeth may begin looking yellow or grey in color. The edges of the teeth may become chipped and uneven, or even look sawed off. As the teeth shorten, they start to disappear from the smile. The patient's lips look thinner as the upper lip rolls over the short upper teeth. This shortening of the teeth provides, for many, an undesirable aging effect. Shortened teeth and bad bite and jaw positioning cause a person's face to physically shorten with age such that he looks older than he would with teeth that are not worn down. The jaw position is directly affected leaving the overall shape of the face and profile compromised. The mouth, lips, cheeks, neck, speech, ability to chew, jaw position and airway are all adversely affected by this physical shortening of the face. The bite and the jaw joints (TMJ) are not physically functioning in harmony.

### Reduced Airway

One consequence of a shortening face, eroded, and/or aging bite and jaw position is a reduced airway. As the access to the airway gets smaller, it becomes more difficult to breath as efficiently because there is less room for the tongue. Without efficient breathing and adequate sleep, a person may lose energy and vitality, causing his appearance to seemingly age prematurely. Many people do not sleep as well as they slept when they were younger because of the reduced airway access caused by a collapsing bite and shifting jaw position and tongue. Due to the smaller airway, a person may start to snore and also wake up several times during the night as his body fights for oxygen. Many people seek treatment and/or start taking sleeping pills. Unfortunately, these sleeping pills (and alternatives) do nothing to treat the actual problem of an aging bite, a decreased blood oxygen level, and a shifting jaw position. An older person's uncorrected bite and shifted jaw position may cause a drop in normal blood oxygen levels, a compromised chewing ability and reduced nutrient absorption, which ages him or her from the inside out.

### Traditional Dentistry Solutions

Traditional dentistry attempts to resolve some of those problems presented above by providing a full mouth reconstruction and bite correction procedures, via invasive oral surgery, grinding down healthy teeth to attach new dental crowns or porcelain veneers. Some dentists use pain medication, and/or extended wear-time in braces and orthotic appliances. Traditional dentistry focuses on problems that can be seen, such as removing tooth decay, extracting hopeless teeth, placing porcelain crowns, fillings and dental implants. Traditional dentistry typically involves grinding down teeth for porcelain crowns or veneers that may give a patient whiter teeth and an improved smile while compromising their health and never helping the patient achieve an ideal bite position because their treatments are highly invasive and risky compared to the non-invasive restorations. However, when the patient is not smiling, the benefit of cosmetic dentistry and the whiter smile is lost on the viewer. Other traditional solutions for anti-aging techniques are face-lifts. Anti-aging dentistry is nothing more than a new name for the old methods. However, face-lifts cannot physically lengthen a person's face, improve the patient's health with bite correction, correct the jaw position, or support the person's cheeks and/or lips. Traditional under bite treatment options may include porcelain veneers and cosmetic camouflage, palatal expanders, reverse-pull face mask, orthodontic braces, clear retainers and jaw surgery.

### Embodiments

Embodiments provide methods and systems for providing facial support and facial proportioning non-invasively and without grinding down healthy teeth, including a novel method for bonding a non-invasive dental restoration to each individual tooth on all of the patient's upper teeth and/or all of the patient's lower teeth without harming the teeth. The dental restoration for this new bite position is designed around the patient's specific TMJ anatomy in order to improve the patient's comfort and health, as well as the efficiency and aesthetics of the patient's lower jaw, facial shape, soft tissue of the face, and facial proportions. The term, “non-invasive” as it relates to the embodiments, refers to the approach, process, and application of the restorations to the patient's natural teeth with the exception of technical interferences, wherein the patient's healthy natural teeth are not subjected to drilling, cutting, or grinding by a dental drill or any other mechanism. More specifically, injections and anesthetic are not needed for the patient's comfort in the adjustment of technical interferences nor in the application of the restorations, as the patient's healthy teeth are not altered such that they cannot remain as healthy natural teeth without the need for a dental appliance, crown, veneer, filling, etc.

Lumineers®, Vivineers® and other cosmetic dentistry type of porcelain veneers are non invasive but do not correct the bite or improve the jaw position.

Embodiments involve a three dimensional approach to the patient's bite and jaw position treatment, enabling the patient's bite to be designed such that his jaw is repositioned easily, and his teeth neutrally support the soft tissue of his face. As such, embodiments enable the improvement of a person's entire facial appearance and thereby the attainment of a younger look, without facial surgery, implants, Botox and/or the injection of facial fillers, braces and without the grinding down of healthy teeth.

When the patient's bite and jaw position are idealized, the patient's teeth and dental restorations that are bonded thereon provide adequate support for the patient's facial structure, an enhanced facial shape, and improved profile proportions. In general, the idealized (or modified) bite and jaw position of a patient is a bite and jaw position that significantly improves the positioning and proportions of the bite and jaw over that which currently exists such that the adverse effects of a poor bite and jaw position described herein are reduced or eliminated. Thus, the dental restoration bonded onto a patient's teeth in accordance with embodiments, not only reverse years of tooth wear but function to support the patient's soft tissue (e.g., lips, cheeks) for a more youthful appearance for the patient. For example, thin lips can appear fuller without artificial fillers and implants because the lips are supported by the patient's newly restored bite position. In another example, the patient's jawline looks stronger or in better proportion to the rest of the patient's face. Thus, the shape, length and proportions of the patient's face are optimized via the idealization of the patient's bite and jaw positioning.

As will be further discussed below, various embodiments include, but are not limited to, any of the following method steps: 1) replacing dental work in patient's mouth; 2) gathering data; 3) defining goals; 4) testing assumptions; 5) designing a new bite and jaw position; 6) trying-on the new restorations in advance of bonding for patient approval; 7) bonding the new restorations; 8) fine tuning the bite and jaw position; and 9) protecting the investment. It should be appreciated that the foregoing steps may occur in a different order from that which is described below. Of further note, the dentist performing the methods described herein, in accordance with embodiments, will need expertise (and/or access to such expertise) in TMJ medicine and bite adjustment dentistry, as well as be experienced with full mouth reconstructions. As will be shown, embodiments enable achieving the patient's best bite position non-invasively by providing the ideal jaw position for the patient's facial structure and health.

Reference will now be made in detail to embodiments of the present technology for providing facial support and facial proportioning without surgery or grinding down healthy teeth, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures and components have not been described in detail as not to unnecessarily obscure aspects of the present embodiments.

The method steps of idealizing a bite and jaw position of a patient are explained below, in accordance with embodiments.

### I. Replacing Dental Work in the Patient's Mouth

Many times, a patient has a variety of old dental work on his teeth, applied at different times, over a span of many years. Old and older technology is found within the patient's mouth, none of which is built onto the teeth to coordinate with each other to achieve the ultimate objective of idealizing the patient's bite position. In one embodiment, the dentist replaces all of the patient's old dental work (e.g., crowns, fillings) with a new layer of protection, all of the new dental work will be applied in coordination with each other, to maximize and idealize the patient's bite and jaw positioning.

A patient who has received treatment according to embodiments may experience the reversal of premature aging, better lip and soft tissue support, reduced facial folds or wrinkles, a better overall facial shape and improvements in his chin jawline and facial profile. Thus, a patient who has received treatment according to embodiments may experience less jaw tension and TMJ pain, better sleep, more efficient and comfortable chewing capacity, easier digestion, and a more youthful appearance. Having an optimized jaw and bite position that is achieved non-invasively benefits a patient's health because it benefits the patient's entire body.

Of note, traditional teeth reconstruction treatment either replaces all of the old crowns, old fillings or bad porcelain veneers during a period of weeks, several months or even years. When performing this type of reconstruction treatment over a period of several months or years, the individual teeth may be improved, but the height and position of the bite as well as the jaw position remain the same as it was before the treatment began. This means if the patient has a weak chin or an aging face before the treatment, the patient will not likely experience any cosmetic improvements under traditional treatment methods. Likewise, if the patient has TMJ pain or headaches resulting from a bad bite and jaw position, they will not likely experience any health benefits relative to their jaw pain and headaches, as traditional treatment methods will not improve the position of the bite and jaw.

When performing traditional reconstruction treatment over just a few weeks, the dentist has an advantage in having the opportunity to have all of the porcelain prepared at the same time. By preparing all of the porcelain at the same time, the porcelain color will match and the function of the bite can be moderately improved. Missing teeth, chewing issues, tooth sensitivity and decay may be dramatically improved in this type of reconstruction. However, since this type of bite reconstruction does not involve idealizing the jaw position, the patient will not likely experience any anti-aging benefits or improvements to his facial shape or profile. Likewise, performing traditional reconstruction treatment involves grinding down several, if not all, of the patient's teeth upper teeth and/or lower teeth, leaving the teeth structurally compromised and with significant risks to and/or additional undesirable effects for the patient, including but not limited to, tooth sensitivity, tooth loss, root canal treatment, pain: both temporary and long-term, dental implants, replacing restorations in the future, etc.

### II. Gathering Data

In various embodiments, the dentist conducts a dental examination of the patient. The dentist investigates/examines any, but not limited to, of the following: the patient's history, dental health, bite position, previous dental treatment, how the patient speaks and moves, the patient's speech problems and/or bite interferences that affect the patient's diction and/or movements, bite balance, comfort, deviations, wear and function, which of the patient's teeth are visible when the patient speaks, periodontal charting, the patient's tissue, the overall shape of the patient's face, where the patient may need soft tissue support (e.g., lips, corners of the mouth, below the jawline or chin, cheeks), which lips need support, the patient's profile to determine if he could benefit from better proportioning (e.g., does the patient's chin stick out, is the patient's lower jaw weak and recessed, is one of the patient's lips more prominent than the other, is the patient's mouth sunken in and are the patient's lips squished), aspects of the patient's TMJ (e.g., clicking, popping, irregular movement, deviations, overbuilt muscles, tension, and facial movement), signs of wear and grinding of the patient's teeth, gum recessions, fractures, thinning enamel, dental x-rays, areas of infection, areas of potential infection, and the patient's own description, opinion, and assessment of their symptoms, concerns, and goals.

The dentist then demonstrates to the patient the effects while using a bite tester appliance that is intended to simulate a reconstruction of the teeth that would idealize the patient's bite and jaw position. The dentist determines the best bite tester of the different sizes of bite testers, through and acute observation of the patients jaw movements and known or observed information from the dental examination, that best simulates the patient's ideal bite and jaw position.

Once the best bite tester is determined, the dentist takes head shot photos, profile shots, and mouth photos of the patient, with and without the bite testers in place. In some cases, before treatment videos are also taken.

The dentist will also take impressions for creating a dental model of the patient's upper and lower dental arches and ultimately for creating bite test restorations to be worn by the patient. The testing restoration is made out of thermal plastic, in one embodiment. This thermal plastic is melted over the top of the dental model of the patient's teeth as a base. The test restoration's height is then adjusted three dimensionally according to observations of the patient by the dentists, the jaw position imaging and the patient's feedback, comfort, speech and movements to achieve an improved bite via the test restoration.

### III. Defining Goals

In various embodiments, the dentist will discuss any specific goals the patient has with regard to tooth reconstruction and whether these goals are realistic. For example, the patient and the dentist may discuss the possibility of a wider smile, a younger face, a better looking profile, TMJ pain relief, etc.

In one embodiment, the dentist will discuss color options for reconstructive work. For example, the dentist may point out that the porcelain color that could be chosen is that color that is closest to the whites of the patient's eyes, which will give the patient's face color balance and harmony.

In one embodiment, the dentist will discuss the general style and shape of restorative work that the dentist is recommending and why such a recommendation is being made. The dentist will explain to the patient that the patient is not taking a risk by allowing the dentist to make some style decisions on his behalf as the patient will try-on the restorations and that they will not be bonded into place until the patient approves. The patient will get to wear the restorations around the office without anesthetic because their teeth are intact and with assistance walk outside to natural light to determine if the patient likes the look. The problem with the old tooth grinding method for a full mouth reconstruction is that the patient is now physically compromised with ground down teeth that are sensitive that prevents the patient's ability to try in the new porcelain without anesthetic. Anesthetic changes the patients soft tissue movements, jaw position and bite perception. Any changes that the patient may desire to be made to the porcelain restorations may be completed overnight or over a prearranged timeline. At the next appointment, the patient may then be able to try-on the altered/modified restorations. Only when the patient gives his approval (the assumption being that the patient is satisfied with the proposed results) will the restorations be bonded into place in the patient's mouth.

In one embodiment, the dentist will explain to the patient the necessary steps to be taken to achieve good oral health and what is expected of the patient before, during and after treatment.

### IV. Testing Assumptions

In one embodiment, testing assumptions occur during the observation and exploration period of the test restoration. The dentist makes any necessary three-dimensional bite adjustments to the testing restoration based upon observation of the patient, the images of the TMJ with the appliance in the patient's mouth, the patient feedback and the quality of fit of the restorations.

The dentist takes TMJ positions of the patient's bite: the mouth opened wide; the mouth biting without the restoration therein; the mouth biting with the testing restoration therein; and the mouth at rest. New technology is being developed for jaw imaging of this type so in the future; complex motion tomography will be replaced with some type of Cone Beam technology when the companies that produce these machines can reduce the amount of radiation that is exposed to the patient. Presently, however, the complex motion tomography appears to have the lowest radiation exposure to the patient.

Based upon the x-ray results of the complex motion tomography images, the testing restoration may be adjusted if necessary to improve the jaw position. When considering altering a patient's jaw position, it should be appreciated that in traditional dentistry, dentists x-ray a patient's jaw joint with a CAT scan or cone beam machine to gain a detailed digital images of the position of the patient's jaw bone and the placement of an implant during a surgical procedure. As the CAT scan machine gives off high amounts of undesired radiation, the dentist is only able to take one or a limited number of images of the patient, because of the high radiation exposure to these machines at this time, thus limiting the dentist's ability to gather all the information for other treatments as dental implants and jaw surgery but the radiation level is too high for multiple positions.

In the alternative, the dentist takes a large amount of CAT scan images, thus exposing the patient to large amounts of undesired radiation to the head. Embodiments, on the other hand, provide a method in which a complex motion tomography machine is used to take images showing the patient's jaw joint in multiple positions before and after testing restorations are fitted onto the patient's teeth. The complex motion tomography machine emits minimal radiation and the qualities of the resulting images are useful for determining the patient's ideal jaw position; and ultimately for developing the necessary jaw repositioning bite.

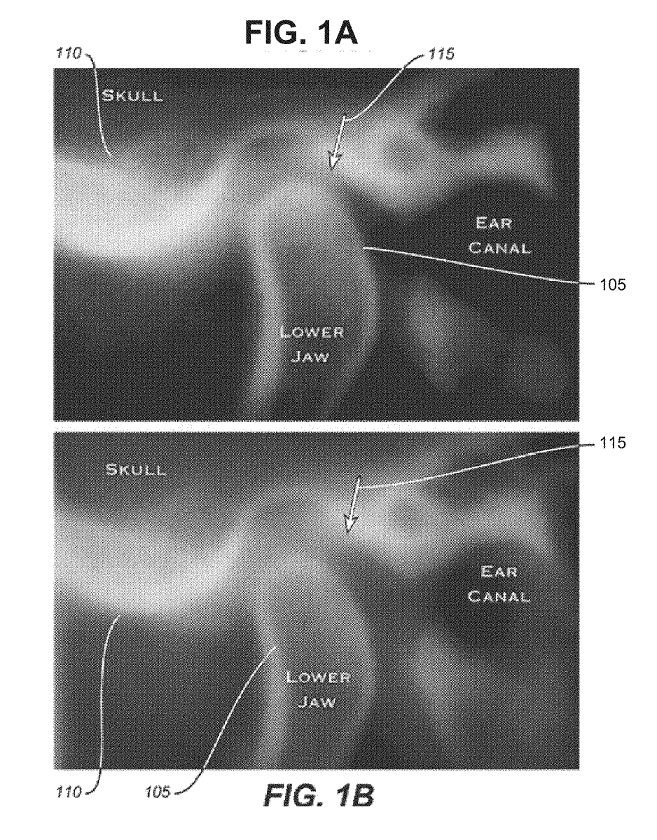

FIGS. 1A and 1B show TMJ images taken with a complex motion tomography machine, in which a portion of the mandible of the patient is shown in relation to the patient's skull and ear canal. FIG. 1A shows the neck portion 105 of the mandible positioned centrally within a socket of the patient's skull 110. The arrow 115 points to the gap between the neck portion of the mandible and the socket of the skull. FIG. 1B shows the neck portion 105 of the mandible positioned left of center within the socket of the patient's skull 110, leaving a wider gap between the neck portion and the skull. In one embodiment, the testing restoration placed on the patient's teeth allows the patient's lower jaw (mandible) to move to its natural and healthy position which is forward and downward. The TMJ images taken of the patient without (FIG. 1A) and without (FIG. 1B) the testing restoration show the effect the testing restoration has on the patient's jaw positioning.

For example, the first image 1A shows that the patient has an overbite and the jaw is being pushed back towards the patient's ears and is not functioning in the center of the jaw joint. This is why so many people have headaches, jaw pain, clicking and popping jaw joints, hearing problems, sleep problems and head and neck pain.

In FIG. 1B, the jaw position is now in the center of the joint so the dentist can understand that this is the ideal jaw position and can verify that the test appliance has the lower jaw in the optimal position for health and function. The patient can now take the “bite test appliance” home and wear it during the day and night. They can test this new jaw position and decide if they are more comfortable and if their pain is reduced or eliminated.

Thus, in one embodiment, the dentist has the ability to determine, test and verify the jaw position with the bite test appliance before any treatment is done to the patient. The diagnosis is non-invasive, the bite test appliance is non-invasive and the entire treatment is non-invasive. The only part that is invasive is replacing all of the existing old dentistry in the patient's mouth. For maximum health, the patient will have matching individual dental restorations that were all built at one time to achieve the best bite and jaw position for the patient's facial structures.

The dentist follows up with the patient after the testing restoration is worn for a prearranged period of time, to assess the patient's response to the fit of the testing restoration. For example, the dentist will inquire if the patient is comfortable or if any of the previous problematic symptoms of a poor bite positioning are subsiding.

### V. Designing a New Bite and Jaw Position

In various embodiments, based upon the TMJ images taken via the complex motion tomography machine, patient feedback, information gathered from the testing restoration, and observations made by the dentist, the dentist takes impressions of the patient's teeth for the application of the restorations to be bonded upon the current dental arch(s).

### VI. Trying-On the Restorations

In various embodiments, the bite testing restoration is removed and the restorations intended to be the final phase of treatment are slid onto the patient's teeth. The patient is reminded not to bite down hard on the restoration(s), due to the possibility that the restoration(s) might break and move. The patient is able to walk around, including going outside to natural light with assistance to consider the overall look and color of the restoration(s) at this time. In one embodiment, the results are referred to as the Face lift Dentistry® method.

### VII. Bonding the Restorations onto the Patient's Teeth

In various embodiments, using the method described below, the dentist bonds onto the patient's teeth the restoration that was created based on the testing restoration, complex motion tomography images, examination, and/or observations. Embodiments provide a bonding method that does not require pain medication and the grinding down of healthy teeth. Further, in preparing the patient's teeth for the bonding of the restoration, the dentist uses a high powered magnification device. Via this magnification device, the dentist is able to view any surface contaminants present on the patient's teeth. The presence of surface contaminants on the patient's teeth has a negative impact upon the ability of the restorations to bond with the patient's teeth. The methodology which the dentist follows to bond the manufactured restoration to the patient's teeth is explained as follows (embodiments may include any of the below steps in various combinations):

1) Use advanced particle beam technology (micro air-abrasion) to blast the patient's teeth with silicon particles and remove all surface contamination completely, thereby significantly increasing the surface area on the teeth to which the restorations may bond. Most dentists do not use a particle beam because the dentists do not have a high speed and high volume suction system to vacuum up the sand blasted materials. It is recommended that every treatment room using this method have an individual vacuum system designed exclusively for the suction of these particles.

2) Apply hydrogen peroxide in some cases to decontaminate the tooth surface. The hydrogen peroxide may be applied to the patient's teeth or gum tissue with a syringe. The use of the particle beam technology may be determined for use by the dentist after using hydrogen peroxide based upon observations of the tooth surface condition.

3) Etch any surface contamination from the teeth, using either a 35% phosphoric etch as determined by the dentists observation of the surface condition of the teeth. The etch activates the surface of the tooth for bonding the restorations. Factors the dentist takes into consideration when selecting an etch may be as follows. The blue etch may have 35% phosphoric acid, but tends to cause the patient's gums to bleed. Bleeding gums contaminate the surface area of the teeth that were just cleaned with a particle beam. Repeat etching may be necessary as determined by the dentist observing the surface condition of the teeth under magnification. 3) Apply a desensitizer and antibacterial material to the teeth that have exposed dentin.

4) Apply a clear coat onto the patient's teeth and cure with a high intensity curing light.

5) Apply a material bonding paste to the tooth that bonds the porcelain to the tooth structure. The selection of the color intensity of this material has a profound influence on the color of the porcelain restorations. Clarification Note: If the patient already had porcelain crowns on some of their teeth, porcelain crowns will replace them that are built to coordinate with the restorations that are placed on the teeth that are intact and healthy.

6) Apply the final restoration to the tooth with the bonding material. Applying the dental restoration to the tooth includes the following steps:

a) Particle beam the restorations and the teeth.

b) Etch the restorations with a hydrofluoric acid if required by the manufacturer depending on the type of porcelain being utilized by the dentist.

c) Apply Saline to the dental restorations.

d) Apply a monomer to the restorations and the tooth and then apply the bonding material in the desired color to the dental restorations.

e) Place the dental restoration on the patient's tooth, causing the bonding material to squeeze out from the space between the restoration and the patient's tooth.

f) Light cure the bonding material for about 2 seconds to get minimal hardening for easier removal.

g) Remove the extra bonding material that had squeezed out beyond the margins of the dental restoration while assuring that the chemical bonds already formed are preserved.

h) Light cure the bonding material.

7) Remove all excess material and separate the contacts.

8) Make adjustments to the restorations that were bonded onto the patient's teeth, such as adjusting the bite adjustments if necessary along with polishing the restorations to a smooth finish bite.

### VIII. Fine Tuning the Bite and Jaw Position of the Patient

In various embodiments, the following aspects may be observed by the dentist in order to determine if the bite should be adjusted: the patient's speech, diction, bite pressure, bite balance, and soft tissue movement; any interference that should be adjusted to improve the patient's speech clarity; comfort, the ability of the patient's lips to move naturally; the symmetrical display of the porcelain restoration(s) when the patient speaks; and possible cosmetic adjustments that should be done to the edges or contours of the porcelain. The dentist also receives feedback from the patient, such as: how does the patient feel; are the pre-treatment symptoms like jaw pain or headaches gone; and is the patient comfortable with his new bite and jaw position. Using the data, a patient video and photos done before treatment and after treatment and results from the complex motion tomography images, taken with the permanent restorations in place, the dentist determines and conducts adjustments to the bite position to further optimize the jaw position. Furthermore, the fine-tuning of the restorations can be determined as desirable by the dentist at any future point.

### IX. Protecting the Investment

In various embodiments, the dentist reminds the patient of the importance of oral hygiene and that the patient's daily health routine and maintenance is very much in their own hands. The dentist designs a custom night guard for the patient to wear while he is sleeping to maintain and preserve the ideal bite and jaw position.

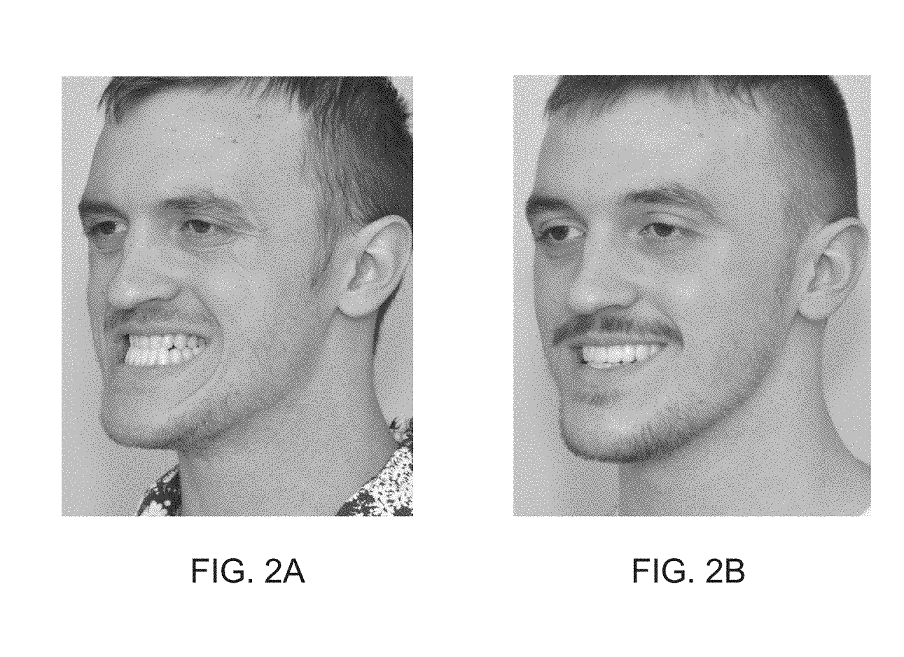

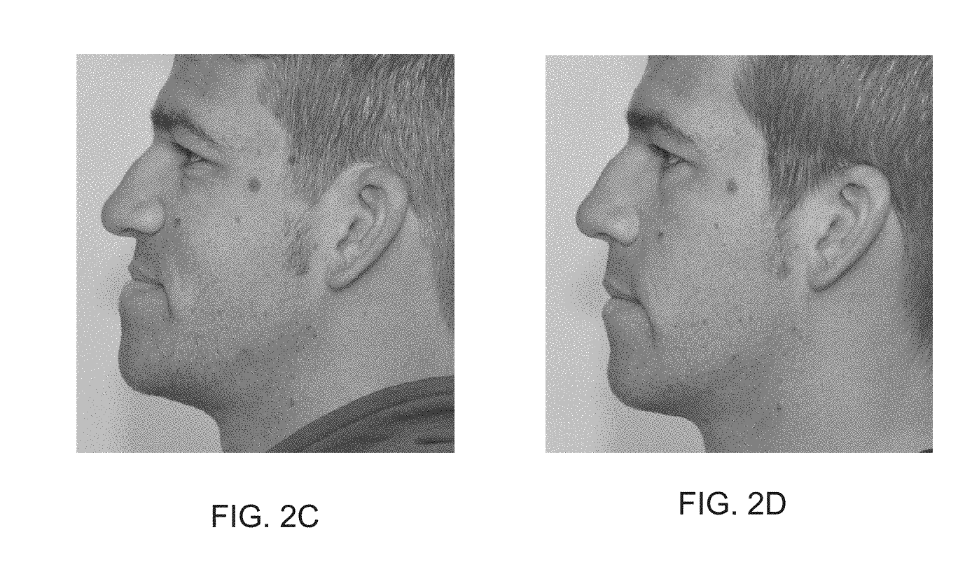

As will be explained below, FIGS. 2A, 2B, 2C, 2D, 3A, 3B, 4A and 4B illustrate before and after pictures of patients with an under bite an overbite, and an eroded or aging bite, the patients having received treatment according to embodiments described herein.

FIGS. 2A and 2B depict pictures of Patient A. FIG. 2A depicts a front view of Patient A before undergoing treatment according to embodiments. Patient A has an under bite with a large lower jaw and a small upper jaw. FIG. 2B depicts a front view of Patient A after undergoing treatment according to embodiments. In both FIGS. 2A and 2B, Patient A is biting their teeth together. In FIG. 2A, Patient A's front teeth do not even touch, making chewing and talking in a normal fashion impossible. In the past, patients wishing to correct an under bite such as this would frequently be directed to have surgery in which the jaw is cut and/or to wear braces for an extended period of time. However, embodiments of the present technology provide for a safer, non-surgical, and non-invasive (i.e. without grinding down teeth) answer to under bite correction. Embodiments idealize the patient's bite and jaw position to not only improve the smile, but also to improve the facial proportions. In other words, the ideal jaw position for the patient's bite is determined and then provided for with embodiments.

FIG. 2C depicts Patient A's profile before undergoing treatment according to embodiments. FIG. 2D depicts Patient A's profile after undergoing treatment according to embodiments. FIG. 2D illustrates Patient A's lower jaw having been physically improved and the bite having been corrected. The lower lip and chin no longer jut out. FIG. 2C illustrates Patient A's under bite position that causes the chin and jaw to protrude. Patient A struggles to chew and speak normally. Additionally, the upper lip looks small and unsupported. FIG. 2D illustrates, upon the application of embodiments, Patient A's jaw in a position such that the appearance of the protruding chin is eliminated. Patient A's upper lip seems supported, rendering a fuller appearance. Further, Patient A's profile proportions appear to be more balanced and normal in appearance.

In receiving treatment, none of Patient A's natural teeth were ground down. Further, Patient A's treatment took two visits about two weeks apart from one another. During and after the treatment, Patient A did not experience any shots to alleviate pain, pain or discomfort.

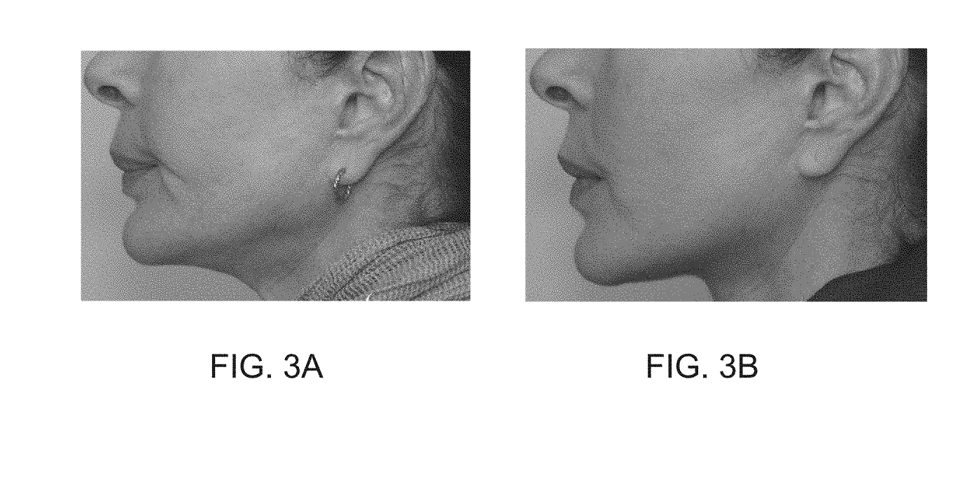

FIGS. 3A and 3B depict a side-profile of Patient B. FIG. 3A depicts Patient B before undergoing treatment. Patient B is shown having an overbite, deep folding of the soft tissue at the corners of the mouth, excess skin around the jawline and chin area, and squished lips are evident. FIG. 3B depicts Patient B after undergoing the treatment method according to embodiments. As shown, after the treatment according to embodiments is applied, Patient B no longer has an overbite, lips are better supported, folding at the sides of the mouth is significantly reduced and the skin if the jawline and chin appears tighter.

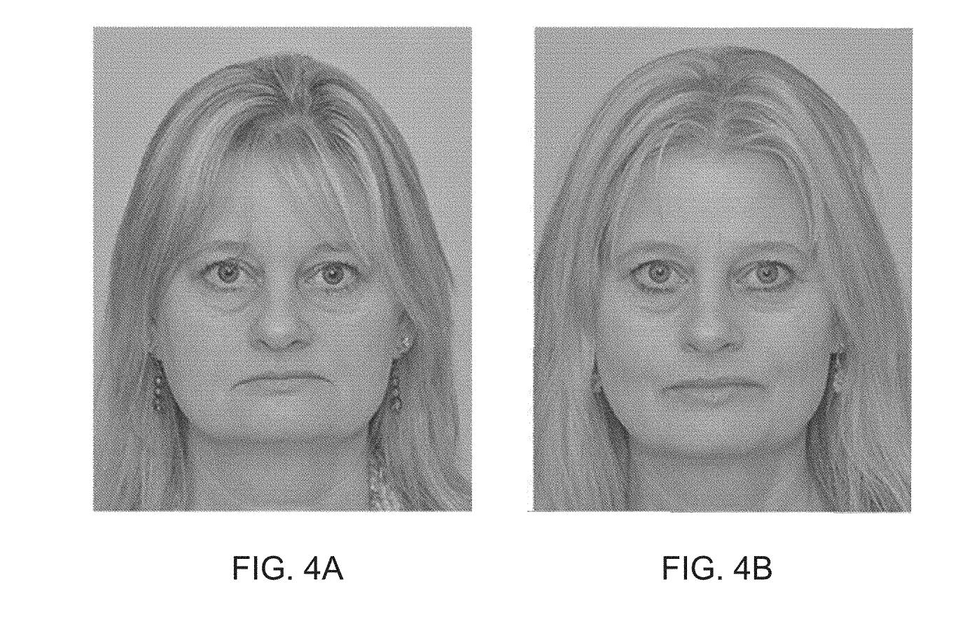

FIGS. 4A and 4B depict pictures of Patient C. FIG. 4A depicts Patient C before undergoing treatment. Patient C is shown having an eroding bite or aging bite, squished lips, turned down mouth (making the appear sad), folds at the corners of the mouth, and a short face that reveals the underside of the chin. FIG. 4B depicts Patient C after undergoing the treatment method according to the embodiments. As shown, after the treatment according to embodiments is applied, Patient C no longer has an eroded or aging bite, the mouth no longer turns down and is level, deep folds and infection at the corners of the mouth are gone, the face is elongated for a more oval facial shape, the underside of the chin is no longer visible, and lips are fuller.

In receiving treatment, if the patient previously had porcelain crowns, new porcelain crowns were made to replace them. All of the healthy teeth were not ground down for porcelain crowns or porcelain veneers; no shots were necessary as they were resorted with the non-invasive restorations. All of the results were achieved according to the embodiments non-invasively and without compromising the health of the natural teeth that did not have previous crowns or veneers.

### Example Methods and Systems

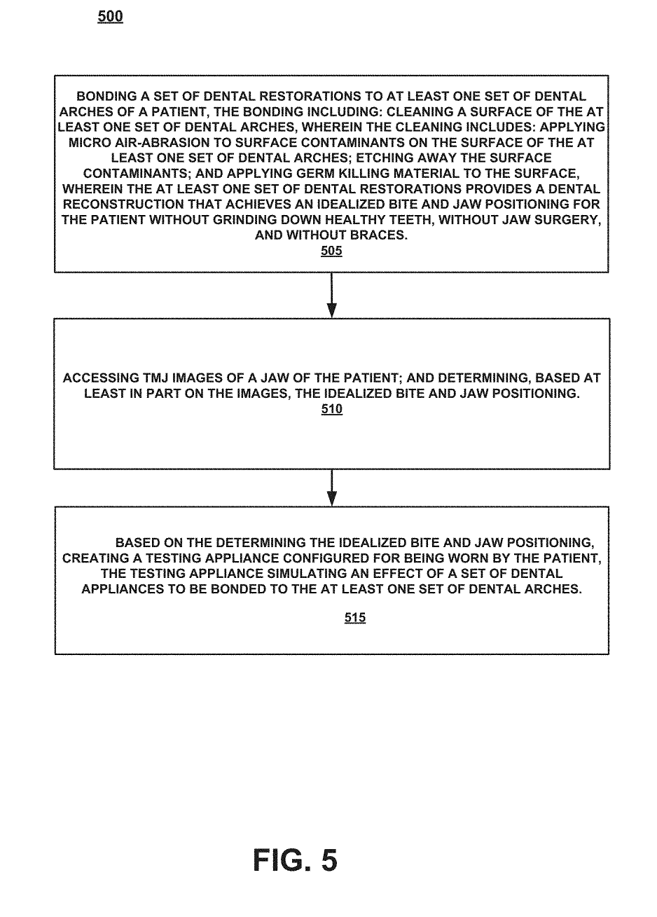

FIGS. 5, 6, 7, 8, 9 illustrate example methods for providing facial proportioning for a patient to realize an idealized bite and jaw positioning, in accordance with embodiments. With reference to FIG. 5 and as is already described herein, the method 500 for providing facial proportioning for a patient to realize an idealized bite and jaw positioning, in one embodiment, includes bonding 505 a set of dental restorations to at least one set of dental arches of the patient. The bonding 505 includes cleaning a surface of the at least one set of dental arches. It should be appreciated that a set of dental arches may be a set of one. In a patient's mouth, there exists the upper dental arch and the lower dental arch.

The cleaning includes: applying micro air-abrasion to surface contaminants on the surface of the at least one set of dental arches; etching away the surface contaminants and activating the surface; and applying a desensitizer and antibacterial material to the surface, wherein the at least one of the dental arches had all of the teeth restored simultaneously provides a dental reconstruction that achieves an idealized bite and jaw positioning for the patient. In one embodiment, the cleaning further includes applying hydrogen peroxide to decontaminate the surface. In one embodiment, the application of the hydrogen peroxide occurs before the application of the micro air-abrasion to the surface contaminants, the etching of the surface contaminants; and the applying the desensitizer and antibacterial material to the surface of the at least one set of dental arches and including all of the teeth in that dental arch. Overbites, under bites and aging bites cannot be treated when only some of the teeth are restored.

In one embodiment, the bonding 505 further includes applying a clear coating layer on the surface and curing the clear coating layer with a high intensity curing light. In another embodiment, the bonding 505 further includes applying a tooth bonding material to the surface, wherein the tooth bonding material is configured for bonding the porcelain restoration to a tooth of the at least one set of dental arches to create a new shape that is enabled to receive a dental restoration. In one embodiment, the dental restoration is applied to the tooth, wherein the dental restoration is in contact with at least a portion of the tooth. In yet another embodiment, at least one set of dental restorations that are bonded onto at least one set of dental arches including all of the teeth is adjusted.

In one embodiment, the method 500 further comprises: accessing 510 TMJ images of the jaw of the patient; and determining, based at least in part on the images, the idealized bite and jaw positioning. In one embodiment, the TMJ images include images of different sides of the patient in different positions.

In one embodiment, the method 500 further comprises: based on the determining the idealized bite and jaw positioning, 515 creating a test bite appliance configured for being worn by the patient, test bite appliance simulates the new jaw position that were visualized on the jaw imaging system to see the ideal jaw position of the patient for maximum jaw function.

In one embodiment, in order to correct the bite, all of the teeth on the upper arch and/or all of the teeth on the lower arch need individual porcelain restorations. The bite cannot be corrected by only treating some of the teeth. This treatment is to treat patients that have a bite that puts the patient at a physical disadvantage and that compromises their health.

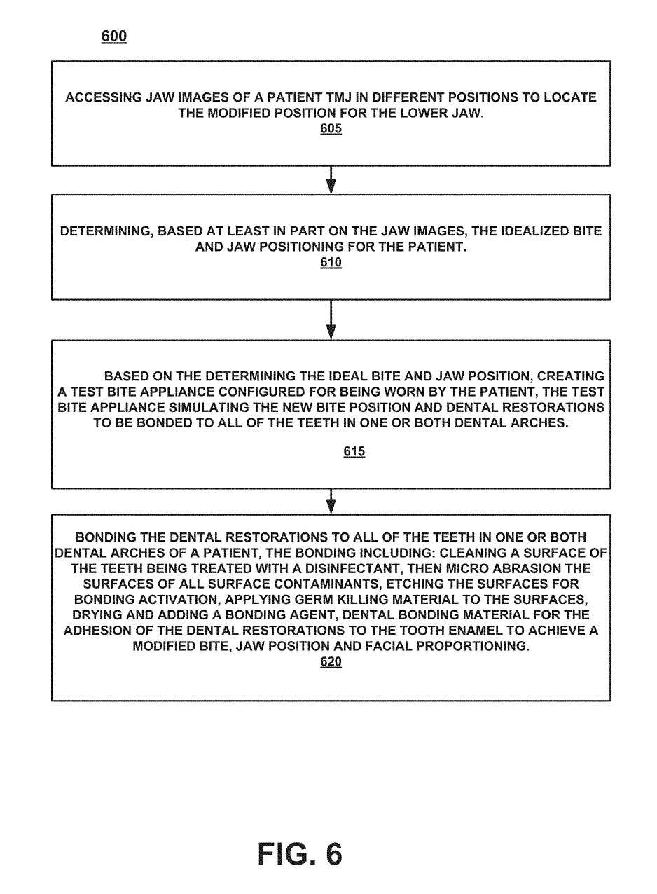

With reference to FIG. 6 and as is already described herein, the method 600 for providing facial proportioning for a patient to realize an idealized bite and jaw positioning. One embodiment includes accessing 605 a jaw image of a patient TMJ in different positions to locate the ideal (modified) position for the lower jaw. On embodiment, determines 610, based at least in part on the jaw images, the idealized bite and jaw positioning for the patient can be tested by the patient wearing the custom made test bite appliance.

In one embodiment, the method 600 further includes, based on the determining 610 the idealized bite and jaw positioning, creating 615 a test bite appliance configured for being worn by the patient, the test bite appliance simulating an effect of a new bite and a new jaw position with a set of dental restorations to be bonded to at least one set of dental arches of the patient. In one embodiment, the TMJ images are images of different sides of the patient and possibly in different positions.

In one embodiment, the method 600 further includes bonding 620 the dental restorations to all of the teeth in one or both dental arches of a patient, the bonding including: cleaning the surfaces of the teeth being treated with a disinfectant, then micro abrasion the surfaces all surface contaminants, etching the surfaces for bonding activation, applying germ killing material to the surfaces, drying and adding a bonding agent, dental bonding material for the adhesion of the dental restorations to the tooth enamel to achieve the ideal bite, jaw position and facial proportioning. Such that the at least one set of dental restorations provides a non-invasive dental reconstruction that achieves the idealized bite and jaw positioning for the patient.

In one embodiment, the cleaning further includes applying hydrogen peroxide to decontaminate the surface. In one embodiment, applying the hydrogen peroxide occurs before the applying of the micro air abrasion to the surface contaminants, the etching of the surface contaminants; and the applying of the desensitizer and antibacterial material to the surface.

In another embodiment, the bonding 620 further includes: applying a clear coating layer on the surface; and curing the clear coating surface with a high intensity curing light.

In one embodiment, the bonding 620 further includes: applying a tooth building material to the surface, wherein the tooth building material is configured for building up a tooth of the at least one set of dental arches to become a shape that is enabled to receive a dental crown.

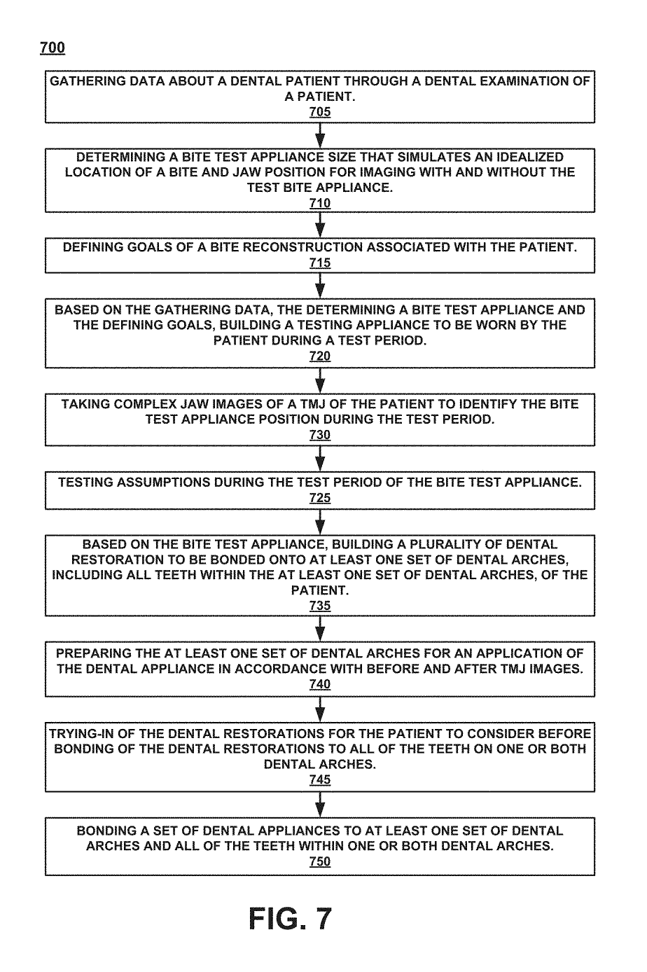

With reference to FIG. 7 and as is already described herein, the method 700 for providing facial proportioning for a patient to realize an idealized bite and jaw positioning, is described. It should be noted that the following discussion is not building a dental appliance, but is instead building individual dental restorations wherein each dental restoration is individually bonded to each of the patient's teeth. That is, each tooth remains separate and the dental restoration becomes part of the patients tooth. They are not meant to be removable by the patient.

At 705, one embodiment gathers data about a dental patient through a dental examination of the patient. In general, examination includes observing the patient's speaking patterns, shape of their face, jaw position clinically, the patient's symptoms and clinical communications as to their motivation for treatment.

At 710, one embodiment determines a bite test appliance size that simulates the idealized bite and jaw positioning and a new shape to the patient's face and jawline. In one embodiment, the skill and experience of the dentist determines the thickness necessary for the test bite appliance from the examination and clinical testing during the examination.

In one embodiment, the bite test appliance is a jawtrac® bite test appliance. Although a jawtrac® bite test appliance is referred to herein, it should be appreciated that there may be other bite test appliances which fall within the scope of the claims provided herewith but which may not be referred to as jawtrac® bite test appliances. The use of the jawtrac® bite test appliance language herein is merely to identify one specific example of a plurality of possible non-invasive restoration systems. For purposes of clarity, the following discussion will refer to the encompassing idea as bite test appliance, of which jawtrac® is one specific example.

In one embodiment, each bite test appliance is made custom for each patient depending on their jaw movement, comfort zone, and the like as determined by the dentist during the examination and clinical testing. The jaw imaging results with the test bite appliance in the patient's mouth are compared to the original bite and jaw position of the patient along with the relaxed jaw position of the patient. In general, the bite test appliance can be made during the same office visit, in a small amount of time, e.g., 15-20 minutes. However, it may also be made in time for a follow on visit if it is preferred.

At 715, one embodiment defines at least one goal of a bite reconstruction associated with the patient. For example, improvement in the patient's comfort and health, as well as the efficiency and aesthetics of the patient's lower jaw, facial shape, soft tissue of the face, facial proportions, and the like.

At 720, based on the gathering data at 705, the determining of the bite test appliance size at 710 and the defining at least one goal at 715, one embodiment builds a test dental restoration to be worn by the patient during a test period so the patient can see the new shape to their face and experience the new jaw position for pain relief.

At 725, one embodiment tests assumptions during the test period of the bite test appliance.

At 730, one embodiment takes TMJ images of the jaw of the patient during the test period. For example, jaw imaging is taken at multiple locations to make sure we are within biologic limits for the TMJ function of the patient.

At 735, based on the testing of the bite, one embodiment builds a plurality of dental restorations to be bonded onto at least one set of dental arches, including all teeth within the at least one set of dental arches of the patient.

At 740, one embodiment prepares at least all of the teeth of one dental arch for an application of the dental restorations in accordance with before and after TMJ images.

At 745, one embodiment trys-in of the dental restorations for the patient to consider before bonding of the dental restoration to all of the teeth on one or both dental arches. For example, the patient wears the bite test appliance, verifies that they are comfortable and takes it home to experience and evaluate the cosmetic and functional benefits. This is the testing phase of the knowledge, expertise and clinical judgement of the treating dentist. Once, the patient confirms their health has improved and that they are ready to move forward with treatment and based on the bite test appliance, dental restorations are constructed for the teeth that are intact and health and existing porcelain crowns are replaced on teeth that already had crowns.

At 750, one embodiment bonds a set of dental restorations to the at least one set of dental arches and all of the teeth within one or both dental arches.

In one embodiment, the bonding of step 750 further includes cleaning a surface of the at least one set of dental arches, wherein the cleaning includes: applying micro air-abrasion to surface contaminants on the surface of the at least one set of dental arches; etching away the surface contaminants; etching the surface and applying a desensitizer and antibacterial material to the surface, wherein the at least one set of dental restorations provides a non-invasive dental reconstruction that achieves the idealized bite jaw positioning for the patient non-invasively and non-surgically.

In one embodiment, bonding the dental restorations improves the chin and jaw position. It also solves many physical issues as headaches, jaw pain, neck pain, muscle tension and stress that enhance the quality of life of the patient. The new dental restorations also improve the shape of the patient's face and facial profile.

Thus, the face lift dentistry® method solves cases that are impossible to treat with orthodontics, cases that already had orthodontics that failed, cases that already had jaw surgery and orthodontics that failed, and cases of full mouth reconstructions using porcelain crowns and porcelain veneers that failed to achieve satisfactory results of the patient.

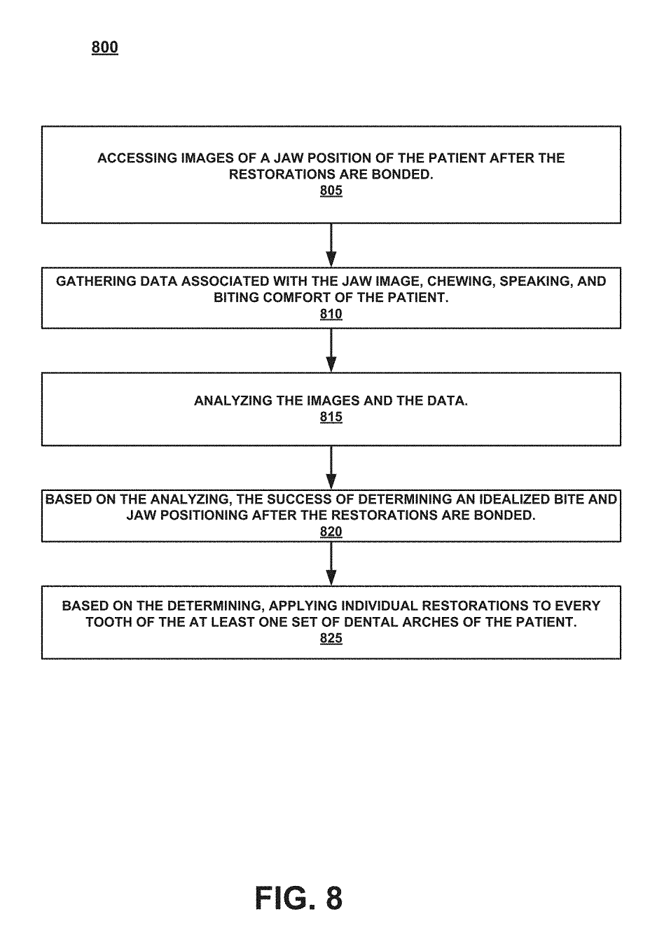

With reference to FIG. 8 and as is already described herein, the method 800 for providing facial proportioning for a patient to realize a younger shape to their face with decreased wrinkles and reversing premature aging, and an idealized bite and jaw positioning, in one embodiment, includes: at 805, accessing images of a jaw position of the patient after the restorations are bonded; at 810, gathering data associated with the jaw image, chewing, speaking, and biting comfort of the patient; at 815, analyzing the images and the data; at 820, based on the analyzing, the success of determining an idealized (e.g., modified) bite and jaw positioning after the restorations are bonded; and at 825, based on the determining, applying individual restorations to every tooth of the at least one set of dental arches of the patient.

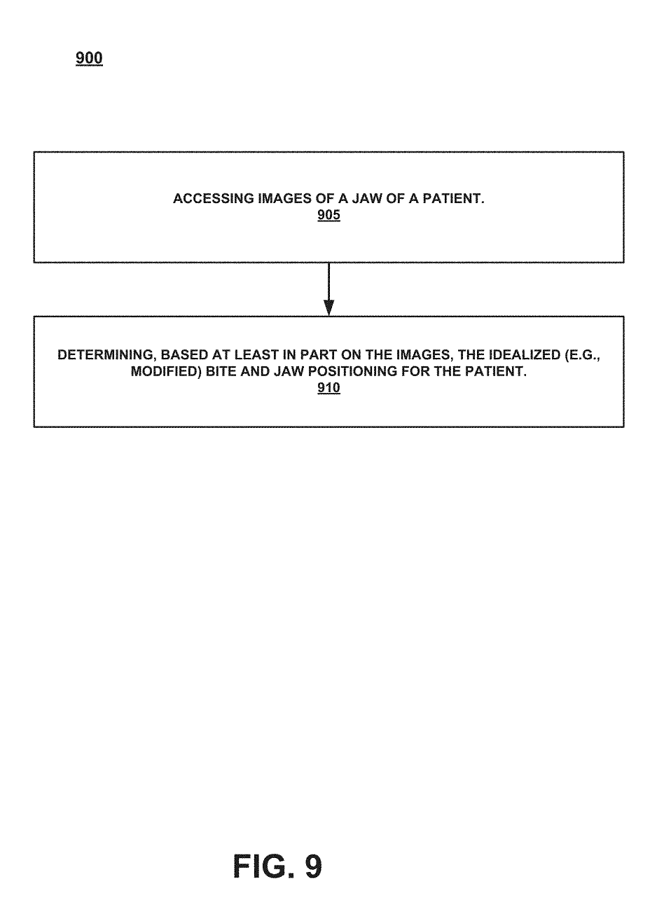

With reference to FIG. 9 and as already described herein, the method 900 for providing facial proportioning for a patient to realize an idealized bite and jaw positioning, in one embodiment, includes: at 905, images of a jaw structure of a patient are accessed. At 910, in one embodiment, based at least in part on the images, the idealized (e.g., modified) bite and jaw positioning for the patient is determined. In one embodiment, the images are complex motion tomography images.

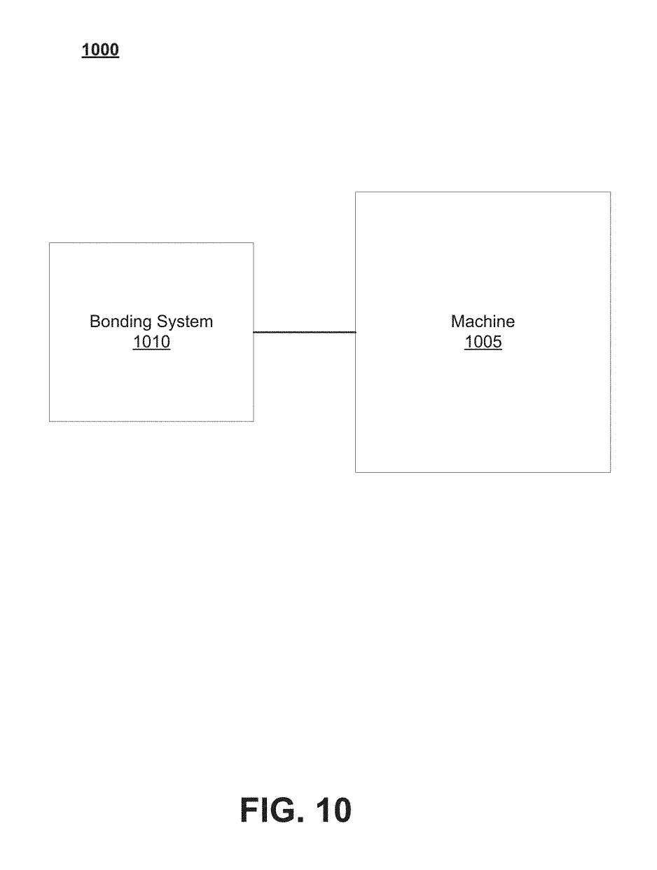

With reference to FIG. 10 and as already described herein, in one embodiment, the system 1000 for providing facial proportioning for a patient to realize an idealized bite and jaw positioning includes: improved chin size, improved facial proportions and reversing premature aging, a machine 1005 for generating images of a jaw of a patient, wherein the images provide information configured for enabling a determination of an idealized bite and jaw positioning of the patient; and a bonding system 1010 for bonding a set of dental restorations to at least one set of dental arches of the patient to achieve the idealized bite and jaw positioning non-invasively. The bonding system includes those materials, machines, and steps already described herein that enable applying the dental restorations (generated according to embodiments) to the patient's dental arches and teeth.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

1. A method for providing non-invasive and non-surgical facial proportioning for a patient to realize a modified bite and jaw positioning non-invasively, said method comprising:
bonding a set of dental restorations to at least one set of dental arches of said patient, wherein said bonding comprises:
cleaning a surface of said at least one set of dental arches, wherein said cleaning comprises:
applying micro air-abrasion to surface contaminants on said surface of said at least one set of dental arches;
etching away said surface contaminants;
chemically activating the surface of said at least one set of dental arches; and
applying a desensitizer and antibacterial material to said surface of said at least one set of dental arches, wherein said set of dental restorations provides a dental reconstruction that achieves an adjusted bite, an adjusted jaw position, a modified chin size, a new facial profile, and a new facial proportion for said patient.

2. The method of claim 1, wherein said cleaning further comprises:
applying hydrogen peroxide to decontaminate said surface.

3. The method of claim 2, wherein said applying said hydrogen peroxide occurs before said applying said micro air-abrasion to said surface contaminants, said etching said surface contaminants; and said applying said a desensitizer and antibacterial material to said surface.

4. The method of claim 1, wherein said bonding further comprises:
applying a clear coating layer on said surface; and
curing said clear coating layer with a high intensity curing light.

5. The method of claim 1, wherein said bonding further comprises:
applying a tooth building material to said surface, wherein said tooth building material is configured for building up a tooth of said at least one set of dental arches to become a shape that is enabled to receive a dental restoration.

6. The method of claim 5, wherein said bonding further comprises:
applying a dental crown or said dental restoration to said tooth, wherein said dental restoration is in contact with at least a portion of said tooth.

7. The method of claim 1, wherein said bonding further comprises:
adjusting said set of dental restorations that is bonded onto said at least one set of dental arches.

8. The method of claim 1, further comprising:
accessing complex motion tomography images of a jaw of said patient; and
determining, based at least in part on said complex motion tomography images, said idealized bite and jaw positioning.

9. The method of claim 8, further comprising:
based on said determining said idealized bite and jaw positioning, creating a testing restoration configured for being worn by said patient, said testing restoration simulating an effect of a set of dental restorations to be bonded to said at least one set of dental arches.

10. The method of claim 8, wherein said complex motion tomography images comprise:
images of different sides of said patient and imaging of different jaw positions to find the ideal jaw position for each individual.

11. A method for providing facial proportioning for a patient to realize an idealized bite and jaw positioning, said method comprising:
accessing complex motion tomography images of a jaw of said patient; and
determining, based at least in part on said complex motion tomography images, said idealized bite and jaw positioning.

12. The method of claim 11, further comprising:
based on said determining said idealized bite and jaw positioning, creating a testing restoration configured for being worn by said patient, said testing restoration simulating an effect of a set of dental restorations to be bonded to at least one set of dental arches of said patient.

13. The method of claim 11, wherein said complex motion tomography images comprise:
images of different sides of said patient.

14. The method of claim 11, further comprising:
bonding a set of dental restorations to at least one set of dental arches of said patient, wherein said bonding comprises:
cleaning a surface of said at least one set of dental arches, wherein said cleaning comprises:
applying micro air-abrasion to surface contaminants on said surface of said at least one set of dental arches;
etching away said surface contaminants; and
applying a desensitizer and antibacterial material to said surface, wherein said set of dental restorations provides a dental reconstruction that achieves said idealized bite and jaw positioning for said patient.

15. The method of claim 14, wherein said cleaning further comprises:
applying hydrogen peroxide to decontaminate said surface.

16. The method of claim 15, wherein applying said hydrogen peroxide occurs before said applying said micro air-abrasion to said surface contaminants, said etching said surface contaminants; and said applying said a desensitizer and antibacterial material to said surface.

17. The method of claim 14, wherein said bonding further comprises:
applying a clear coating layer on said surface; and
curing said clear coating layer with a high intensity curing light.

18. The method of claim 14, wherein said bonding further comprises:
applying a tooth building material to said surface, wherein said tooth building material is configured for building up a tooth of said at least one set of dental arches to become a shape that is enabled to receive the set of dental restorations.

19. A method for providing non-invasive and non-surgical facial proportioning for a patient to realize a modified bite and jaw positioning, said method comprising:
gathering data about a dental patient through a dental examination of said patient;
determining a size of a bite test appliance that simulates an idealized location of a bite and jaw position for imaging with and without the bite test appliance;
defining at least one goal of a bite reconstruction associated with said patient;
based on said gathering data, said size of the bite test appliance, and said defining at least one goal, building a testing restoration to be worn by said patient during a test period;
taking complex jaw images of a temporomandibular joint (TMJ) of said patient to identify a position of the bite test appliance during said test period;
testing assumptions during said test period of said bite test appliance;
based on said bite test appliance, building a plurality of dental restorations to be bonded onto at least one set of dental arches, including all teeth within the at least one set of dental arches of said patient;
preparing said at least one set of dental arches for said dental restorations for a dental bite correction in accordance with before and after TMJ images;
trying-on of said dental restorations for said patient to consider before bonding of said dental restorations to said at least one set of dental arches; and
bonding a set of dental restorations to said at least one set of dental arches and all of the teeth within one or both dental arches.

20. The method of claim 19, wherein said bonding comprises:
cleaning a surface of said at least one set of dental arches, wherein said cleaning comprises:
applying micro air-abrasion to surface contaminants on said surface of said at least one set of dental arches;
etching away said surface contaminants;
chemically activating the surface of said at least one set of dental arches; and
applying a desensitizer and antibacterial material to said surface of said at least one set of dental arches, wherein said set of dental restorations provides a dental reconstruction that achieves said modified bite and jaw positioning for said patient.

21. A method for providing non-invasive and non-surgical facial proportioning for a patient to realize a modified bite and jaw positioning, said method comprising:
accessing images of a jaw position of said patient after a plurality of dental restorations are bonded;
gathering data associated with the images of the jaw position, chewing, speaking, and biting comfort of said patient;
analyzing said images and said data;
based on said analyzing, determining a success of a modified bite and jaw positioning after the plurality of dental restorations are bonded; and
based on said determining, applying individual dental restorations to every tooth of said at least one set of dental arches of said patient.

22. A method for providing non-invasive and non-surgical facial proportioning for a patient to realize a modified bite and jaw positioning, said method comprising:
accessing images of a jaw of said patient; and
determining, based at least in part on said images, said modified bite and jaw positioning for said patient.

23. The method of claim 22, wherein said accessing comprises:
accessing images of a jaw, wherein said images comprise complex motion tomography images of a jaw of said patient.

24. A system for providing non-invasive and non-surgical facial proportioning for a patient to realize a modified bite and jaw positioning, said system comprising:
a machine configured for generating images of a jaw of said patient, wherein said images provide information configured for enabling a determination of an adjusted bite and an adjusted jaw position of said patient; and
a bonding system for bonding a set of dental restorations to at least one set of dental arches of said patient to achieve said adjusted bite and adjusted jaw position, a modified chin size, a new facial profile, and a new facial proportion for said patient,
the bonding of the set of dental restorations being performed non-invasively.
